(19) United States
(12) Patent Application Publication
(10) Pub. No.: US 2006/0126085 A1
(43) Pub. Date: Jun. 15, 2006

(54) Non-linear colorization for imaging systems

(76) Inventors: Robert A. Owen, Rowlett, TX (US); Mark A. Gohlke, Plano, TX (US); Humphrey W. Ha, Plano, TX (US); Alfredo Mendez, Flower Mound, TX (US)

Correspondence Address: O'KEEFE, EGAN & PETERMAN, L.L.P.;Building C, Suite 200, 1101 Capital of Texas Highway South, Austin, TX, 78746, US

(21) Appl. No.: 11/140,840

(22) Filed: May 31, 2005

Related U.S. Application Data
(60) Provisional application No. 60/635,063, filed on Dec. 10, 2004.

(51) Int. Cl. H04N 1/60

(52) U.S. Cl. 358/1.9

(57) ABSTRACT

Systems and methods are disclosed for non-linear colorization in imaging systems. More particularly, colorization of video outputs of thermal imagers (which are typically black and white gray scale imagers) are provided that enhance desired aspects of the displayed image. Specifically, the color in the video output has direct relationship to the measured temperatures of the scene under observation, and color is mapped to temperature through a non-linear relationship that may be changed dynamically depending upon scene content and that exists between temperature and video output.

### RELATED APPLICATION

This application claims priority to the following co-pending provisional application: Provisional Application Ser. No. 60/635,063 filed Dec. 10, 2004, and entitled “TEMPERATURE BASED COLORIZATION IN A THERMAL IMAGING SYSTEM,” which is hereby expressly incorporated by reference in its entirety.

### NOTICE OF COPYRIGHT

A portion of this patent document contains material, which is subject to a copyright protection. The copyright owner has no objection to the reproduction by anyone of the patent disclosure, as it appears in the Patent and Trademark Office patent files or records, but otherwise reserves all copyrights whatsoever.

### TECHNICAL FIELD OF THE INVENTION

This invention relates to techniques and architectures for displaying information obtained through imaging systems and, more particularly, infrared imaging systems displaying thermal images for fire fighting, security, industrial, law enforcement, homeland security, and automotive applications.

### BACKGROUND

Digital imaging systems are often used to display digital images of a scene to a user. With respect to infrared or thermal digital camera systems, digital signal processing within those systems converts infrared radiation, visible light, and thermal information into a displayed image in visible light frequencies. As such, a user can see relevant information on the display. With respect to thermal imaging, the displays are typically black and white images with gray scaling used to show temperature variations. This gray scaling is intended to provide useful information to the user.

To enhance this information, some prior solutions have used color lookup tables mapped against a linear video output relationship with respect to temperature, or they have simply used a “false” color scheme that is based solely on the black and white gray-scale video output level. These prior solutions, therefore, have not taken effective advantage of colorization of the resulting image to enhance the thermal information being conveyed to the user.

### SUMMARY OF THE INVENTION

The present invention provides non-linear colorization for imaging systems to enhance aspects of displayed images. More particularly, the present invention provides systems and methods for providing color in the video outputs of thermal imagers. Specifically, the color in the video output has direct relationship to the measured temperatures of the scene under observation. In contrast with prior systems, however, the present invention maps color to temperature through a non-linear relationship that may be changed dynamically depending upon scene content and that exists between temperature and video output.

In one embodiment, the present invention is a thermal image processing system, including a thermal image sensor having a plurality of individual detectors configured to detect thermal energy from a scene; an image signal processor configured to convert signals from the detectors to digital pixel values related to thermal energy detected by the detectors, to assign a temperature value to each digital pixel value, and to apply non-linear colorization to the digital pixel values to provide colorized image temperature information; and a display system coupled to receive the colorized image temperature information from the image signal processor and to display an image to a user. As described below, other features and variations can be implemented, if desired, and related methods can be utilized, as well.

In one embodiment, the present invention is a colorization processing system for thermal imaging, including a digital input stream representing temperature values for image pixels representing temperatures within a scene, colorization circuitry coupled to the digital input stream and configured to apply non-linear colorization to the temperature values based upon colorization parameters, and color segment control circuitry coupled to the colorization circuitry to provide different sets of colorization parameters depending upon a location of the temperature values within a temperature range. As described below, other features and variations can be implemented, if desired, and related methods can be utilized, as well.

In one embodiment, the present invention is a method for colorization of images in an imaging system, including receiving a digital input stream representing digital values for image pixels representing detected scene energy, and applying colorization to the digital input stream such that a relationship between a range of digital scene energy values and a range of color values is non-linear. As described below, other features and variations can be implemented, if desired, and related systems can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A is a block diagram for a thermal imaging system that utilizes colorization processing according to the present invention.

FIG. 1B is a block diagram for colorization processing according to the present invention.

FIG. 1C is a detailed block diagram for colorization processing according to the present invention.

FIG. 1D is a diagram for color segments based upon scene temperature according to the present invention.

FIG. 2 provides a colorization approach chart according to the present invention showing scene temperature versus color channel value using RGB (Red, Green, Blue) or HSV (Hue, Saturation, and Value) as inputs. It is noted that RGB data can also be noted as GRB (Green, Red, Blue) data.

FIG. 3 provides a temperature transform chart for gray scale input versus gray scale transform output after a non-linear gain and level transform has been applied, as an alternative to traditional linear scaling.

FIG. 4 is a reference image that has not been subjected to colorization processing according to the present invention.

FIGS. 5A-D are an images that have been subjected to colorization processing according to the present invention.

### DETAILED DESCRIPTION OF THE INVENTION

The present invention provides non-linear colorization for imaging systems. More particularly, the present invention provides systems and methods for providing color in the video outputs of thermal imagers to enhance aspects of the displayed image.

One implementation according to the present invention involves mapping a few known temperature points to known outputs in the video and linearly interpolating the color changes that occur between the points. Another approach according to the present invention involves creating a distinct mapping for every output pixel in the non-linear video output that matches temperature to the correspondingly calculated color value for that pixel. Some of the advantageous features provided by the present invention, which are further described with respect to the drawings below, include:
mapping color to temperature in systems with non-linear video processing;
allowing custom color selection and transition throughout the temperature range;
mixing the use of black and white with color in the same scene for intuitive interpretation of the scene;
providing flexible temperature thresholding and isotherm colorization capabilities;
providing a consistent colorization approach whether full scale (on the input) represents white (“white hot” mode) or black (“black hot” mode) on the display;
preserving color information whether in black hot mode or white hot mode polarity displays;
providing the capability to interpolate color within a specific temperature range (and that range only);
providing the capability to create a colorized image that has the appearance of a transparent color overlay (over a black and white base image); and
providing expandability in increasing the number of temperature/color transition points or breakpoints, as desired, for more complex color transforms.

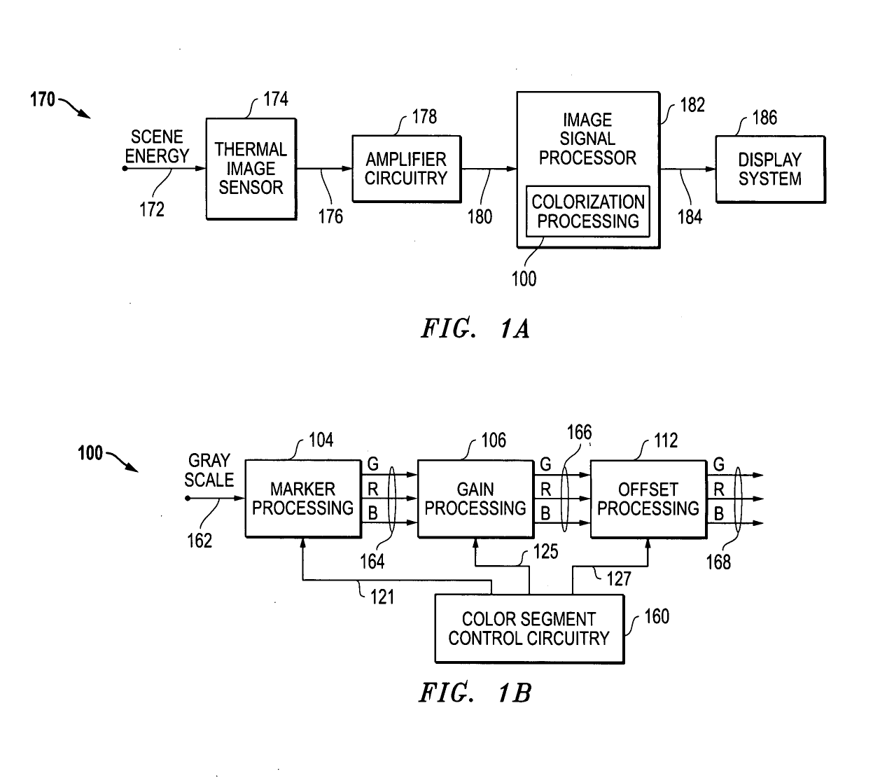

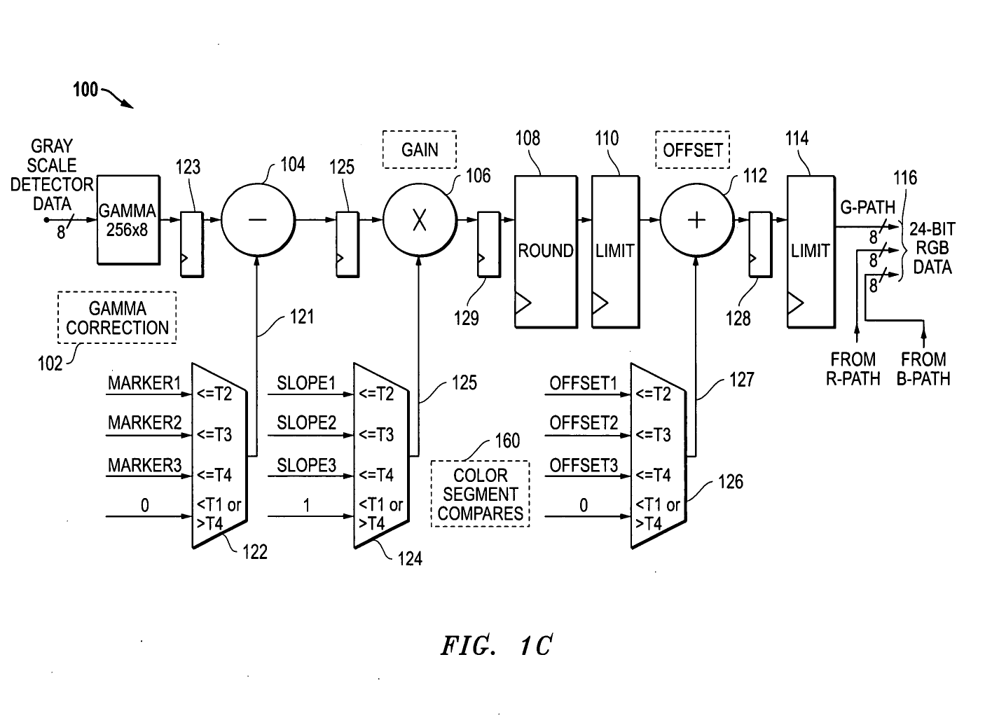

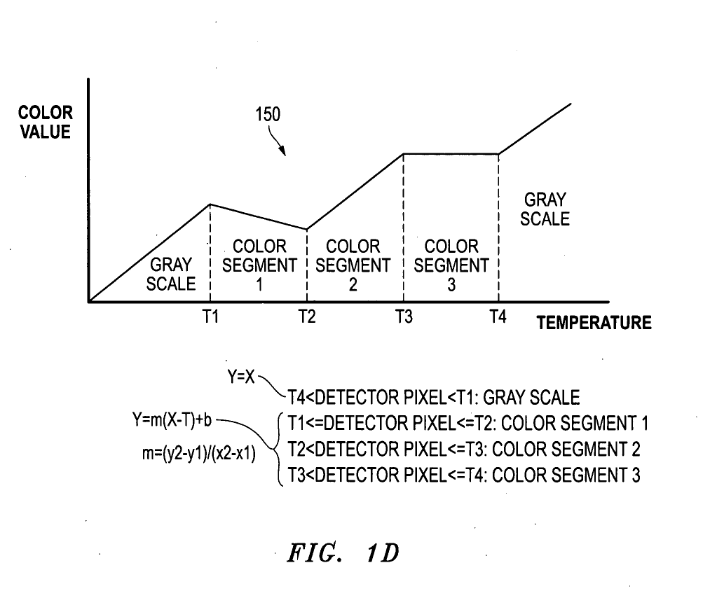

FIG. 1A is a block diagram for a thermal imaging system 170 that utilizes colorization processing 100 according to the present invention. As depicted, scene energy 172 is received by thermal image sensor 174, which may be, for example, an array of pixel cell detectors. The amplifier circuitry 178 receives outputs 176 from the thermal image sensor 174 and provides amplified signals 180 to the image signal processor 182. Image signal processor 182 includes the colorization processing 100 according to the present invention and as discussed in more detail below. The image signal processor 182 then outputs video related signals 184 to display system 186 for display to a user. It is noted that the general operation of thermal imaging systems is known in prior systems. The present invention relates to the colorization processing 100 and related temperature value processing utilized to provide a more useful and informative colorized image to a user. It is further noted that the scene energy 172 is typically focused on the thermal image sensor 174 through a lens system. Such lens systems exist in a wide variety of devices, including infrared lens systems designed for the detection of infrared or thermal radiation in a scene. Such lens systems and related cameras are available from a variety of commercial sources, including from the Infrared Products Division of L3 Communications, the assignee of the current application.

In the embodiment depicted, the output signals from the image sensor 174 are gray scale values. Based upon temperature calibration processes, these gray scale values are mapped to scene temperature such that a temperature value is assigned to the gray scale value. For example, a scene with known temperature points can be detected, and the resulting gray scale output values from pixel detectors the image sensor 174 can be correlated with these known temperature values. In this way, a detector value to temperature map can be created so that temperature values can be assigned to gray scale values and temperature scaling information can be provided on the images displayed to the user.

FIG. 1B is a block diagram for colorization processing 100 according to the present invention. In the embodiment depicted, signal 162 represents gray scale information related to scene energy detected by a pixel cell within the thermal image sensor 174. As discussed above, this gray scale value can also be associated with a temperature value. Marker processing block 104 receives the gray scale pixel data 162 and uses it to output color channel data, such as RGB (red, green blue) pixel data 164, to gain processing block 106. The RGB pixel data 166 from the gain processing block 106 is then passed to offset processing block 112. The marker processing block 104, the gain processing block 106 and the offset processing block 112 provide for colorization processing according to the present invention as described in more detail below. These blocks receive control signals 121, 125 and 127, respectively, from color segment control circuitry 160. As discussed in more detail below, the color segment control circuitry 160 provides a user configurable colorization scheme to the image that greatly enhances the usefulness of the resulting scene to the user.

FIG. 1C is a detailed block diagram for colorization processing 100 according to the present invention. Information is input into the system as gray-scale detector pixel data. The detector pixel data represents the X-bit gray scale information obtained from the detector pixel. In the embodiment depicted, pixel data is serially processed through the colorization processing engine 100, and the X-bit detector pixel values are 8-bit gray-scale values, which represent a digitized representation of scene energy absorbed by a pixel cell within thermal image sensor 174. It is also noted that in the embodiment depicted, the resulting color values at the output 116 of the colorization processing are chosen to be 24-bit values with 8-bits for red, green and blue (RGB), respectively.

As shown, the detector pixel data is first fed into a gamma correction processor 102. The detector pixel data is 8-bit data. The gamma correction block is indicated as 256×8 gamma. This represents a system in which 256 pixel values are remapped, as desired, to compensate for display effects. The detector pixel data then proceeds into the colorization section. Only one of the three color channels is depicted (ie., GREEN or G-PATH). The other two color channels (RED or R-PATH, BLUE or B-PATH) are processed with similar circuitry, although different values can be applied through MUXs 122, 124 and 126, as discussed below, for each of these color channels. At the output, all three color channels (G-PATH, R-PATH, B-PATH) are then concatenated to provide 24-bit RGB data as output signal 116. This output signal 116 can then be further processed as desired by the image signal processor 182 before being provided as video image information to the user.

Looking to the example colorization circuitry depicted for the GREEN data path (G-PATH), depending upon where the detector pixel value falls within the temperature chart 150, as discussed below with respect to FIG. 1D, marker processing subtractor 104 subtracts Marker1 (detector pixel value greater-than-or-equal-to T1 and less-than-or-equal-to T2), Marker2 (detector pixel value greater-than T2 and less-than-or-equal-to T3), Marker3 (detector pixel value greater-than T3 and less-than-or-equal-to T4) or zero (detector pixel value less-than T1 or greater-than T4) from the pixel value as selected using MUX 122. (It is also noted that Marker1, Marker2 and Marker3 are identically T1, T2 and T3, respectively.) Similarly, depending upon where the pixel value falls within the temperature chart 150, gain processing block 106 applies a gain of Slope1 (detector pixel value greater-than-or-equal-to T1 and less-than-or-equal-to T2), Slope2 (detector pixel value greater-than T2 and less-than-or-equal-to T3), Slope3 (detector pixel value greater-than T3 and less-than-or-equal-to T4) or one (detector pixel value less-than T1 or greater-than T4) to the pixel value as selected using MUX 124. Next, the pixel value is processed through rounding block 108 and limiter 110 (which round the non-integer to an integer and ensure the value is clipped to maximum values as needed). At this point, depending again upon where the pixel value falls within the temperature chart 150, offset processing adder 112 adds an offset to the pixel value of Offset1 (detector pixel value greater-than-or-equal-to T1 and less-than-or-equal-to T2), Offset2 (detector pixel value greater-than T2 and less-than-or-equal-to T3), Offset3 (detector pixel value greater-than T3 and less-than-or-equal-to T4) or zero (detector pixel value less-than T1 or greater-than T4) as selected by using MUX 126. This connects the segments as depicted in chart 150. In addition, it is noted that the Offset1, which is “b” in the expression Y=m(X−T1)+b, represents the height of the dashed line above T1 in chart 150. Offset2 and Offset3 similarly represent the height of the dashed lines above T2 and T3, respectfully. Finally, looking back to FIG. 1C, an 8-bit pixel value is processed by limiter 114 and is provided as an output for the GREEN path (G-PATH). It is noted that blocks 123, 125, 128 and 129 represent clocked buffers or registers, and it is noted that blocks 108, 110 and 114 are also clocked. The clocked buffers or registers provide data path synchronization.

FIG. 1D provides a diagram for color segments based upon scene temperature according to the present invention. Temperature chart 150 represents how temperature values are processed based upon the color segment in which they fall. If the pixel value is less-than T1 or greater-than T4, then gray-scale will be used for processing those pixels. This implies that marker=0, slope=1, and offset=0. If the pixel value is less-than-or-equal-to T2 and greater-than-or-equal-to T1, then Color Segment 1 is used for processing those pixels. If the pixel value is less-than-or-equal-to T3 and greater-than T2, then Color Segment 2 is used for processing those pixels. If the pixel value is less-than-or-equal-to T4 and greater-than T3, then Color Segment 3 is used for processing those pixels. Thus, each color segment has associated with it a marker value (T), a slope value (m) and an offset value (b). As such, the following equations represent the relationship between color values (Y) and temperature values (X) for the color segments in FIG. 1D.
GRAY-SCALE Y=X
COLOR SEGMENT (1-3) Y=m(X−T)+b
As depicted, each color segment has a temperature range from a first transition temperature (X1) to a second transition temperature (X2). In addition, as described in more detail below, a first color value (Y1) is assigned for the first temperature, and a second color value (Y2) is assigned for the second temperature. Color values for temperature values between the first and second temperature values are then determined by traveling along a line between the first temperature and the second temperature according to the color segment equation above. In that equation, X is the temperature value, Y is the color value, T is a marker value, b is an offset value, and m is a slope value defined by (Y2-Y1)/(X2-X1). It is further noted that m, T and b represent a set of colorization values for the color segment.

It is further noted that with respect to the color segment equation, each color segment can be configured to be associated with a different slope (m) value (e.g., m1, m2, m3), a different marker (T) value (e.g., Marker1, Marker2, Marker3) and a different offset (b) value (e.g., b1, b2, b3). It is further noted that although three color segments are depicted in FIG. 1D, this number is not required. Fewer or additional color segments could be utilized, if desired, and these color segments could have the same or different parameters depending upon the colorization results desired. In addition, gray-scale and color are both utilized within the colorization example of FIG. 1D. In particular, gray-scale is utilized for the lowest and the highest temperature segments. If desired, color could be used for all pixels with the resulting displayed image depending upon the implementation and visual image desired for the user. In addition, the use of gray scale in combination with color could also be provided as a programmable feature that is user selected, along with user selection of the temperature points for the color segment transition points (e.g., T1, T2, T3 and T4 in FIG. 1D). Thus, the marker, slope and offset parameters for the different color segments, as well as the temperature transition values, can be selected to provide configurable colorization to a scene detected through a detection system. According to the present invention, the plurality of segments provide an efficient mechanism for colorization of the image using non-linear relationships between temperature and color so as to enhance desired information of interest within the scene. Additionally, the marker values can be mapped radiometrically to T1, T2, T3, and T4 so that a non-linear relationship may exist between temperature and the input detector pixel values as depicted in FIG. 3.

Attached as an Appendix below is an example software module directed to colorization for an example channel, according to the present invention. The module represents a portion of the software simulation of the system processing that is depicted in FIG. 1C and FIG. 1D. It is noted that RGB data can also be noted as GRB (Green, Red, Blue) data. It also is noted that although a system block diagram for HSV (Hue, Saturation, and Value) data processing is not shown with respect to FIGS. 1A-D, such HSV-based circuitry would be similar to the RGB block diagrams that are included herein with the actual output values being modified to be HSV data rather than RGB data.

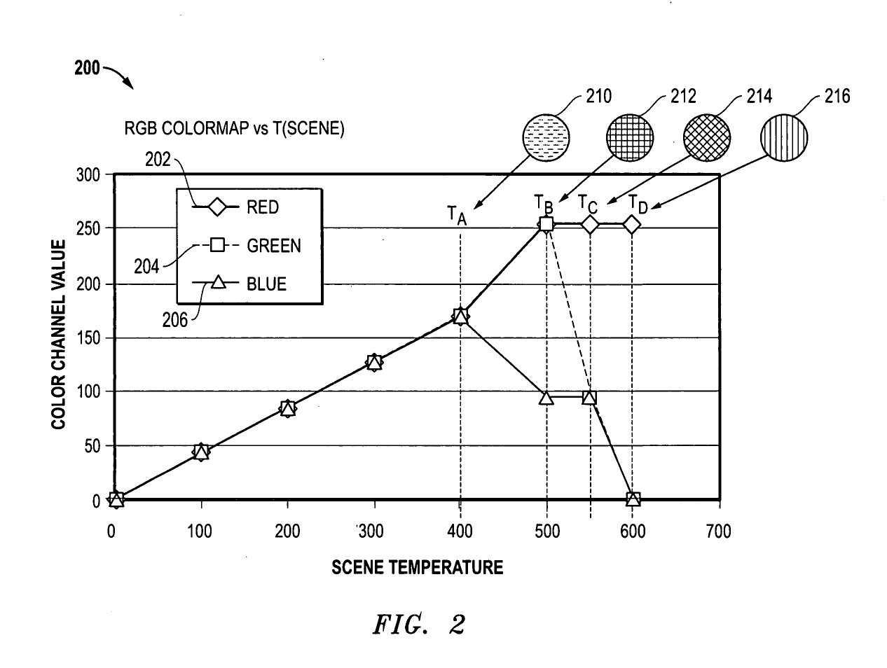

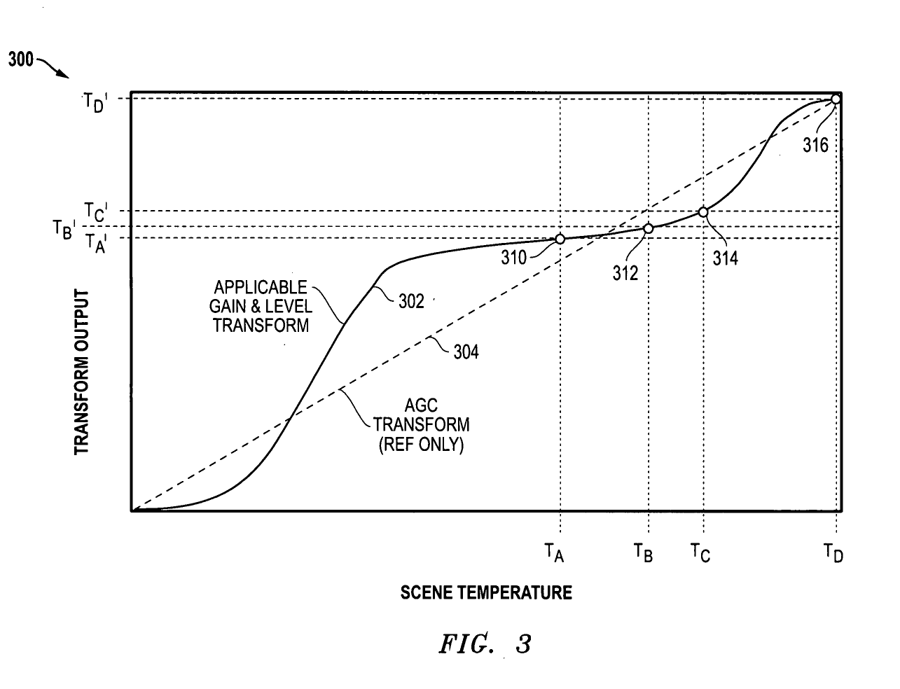

FIG. 2 provides a colorization approach chart 200 showing scene temperature versus color channel value using RGB (Red, Green, Blue) or HSV (Hue, Saturation, and Value) pixel data as inputs. For this chart 200, the X-axis represents scene temperature in degrees Celsius, and the Y-axis represents relative 8-bit color channel values. Line 206 (thin line with triangle symbols) represents the blue pixel information and how the color channel values are shifted for blue pixel information. Line 204 (dotted line with square symbols) represents the green pixel information and how the color channel values are shifted for green pixel information. Line 202 (thick line with diamond symbols) represents the red pixel information and how the color channel values are shifted for red pixel information. The combination of the red, blue, green channels can depict a variety of colors. Although the system described here can depict over 16 million colors, this number may be increased or decreased by changing the number of bits being processed.

As shown in this example, color channel values are processed differently within regions defined by temperature transition points TA, TB, TC and TD. These temperature transition points occur at 400 degrees Celsius, 500 degrees Celsius, 550 degrees Celsius and 600 degrees Celsius, respectively, based upon the scale presented in FIG. 2. The color channel value for blue information is reduced when moving from TA to TB. The color channel value for green is reduced when moving from TB to TC. The color channel values for green and red are reduced to a low level when moving from TC to TD. In contrast, the color channel value for red is moved to high saturation value when moving from TA to TB and then remains at this high level for TB to TC and TC to TD. It is noted that TA, TB, TC and TD correlate to T1, T2, T3 and T4 discussed above.

As shown in FIG. 2, therefore, the colorization of red, green and blue data is processed with different parameters, and these parameters may be made programmable or configurable to allow different image colorization results. For example, the four temperatures TA, TB, TC, and TD can be programmable parameters, as discussed above. And the RGB or HSL values at TB, TC and TD can be programmable values. It is noted that values up to and including TA and beyond TD are maintained as existing gray values, and intermediate RGB or HSL values are interpolated between TA and TB, between TB and TC, and between TC and TD. The color circles 210 (gray), 212 (yellow), 214 (orange) and 216 (red) that point to temperature transition points TA, TB, TC and TD, respectively, are shaded to represents relative changes in colorization at those temperature points. As depicted, therefore, the lightest color point is selected to occur at TB. Thus, it is seen that by adjusting the temperature transition points and the color channel weightings or values at those temperature transition points, temperatures within the scene image can be highlighted or made more clear to the user in the resulting visual image. And according to the present invention, this colorization can be non-linear so that color is not changing in a linear fashion with temperature. Rather, color is changed in a non-linear fashion in order to highlight desired thermal aspects of the resulting image. In addition, it is noted that the colorization techniques described herein could also be utilized more generally for highlighted aspects of displayed images in other types of visual imaging systems that are not thermal imaging systems.

FIG. 3 provides a temperature transform chart 300 for gray scale input versus gray scale transform output after a non-linear gain and level transform has been applied, as an alternative to traditional linear scaling. For this chart 300, the X-axis represents relative scene temperature values (e.g., TA, TB, TC and TD) that relate to the actual temperatures in the detected scene. The Y-axis represents relative gain and level transform values (e.g., TA′, TB′, TC′ and TD′) that relate to a mapping of the input gray scale temperature values to output gray scale values via a non-linear gain and level transform. The dotted line 304 represents a traditional approach of using an automatic gain amplifier (AGC) with a linear transform to map actual temperature values to output gray scale values that are used for image display. This AGC transform line 304 is included for reference purposes only. Line 302 represents an alternative technique according to an aspect of the present invention for using a non-linear gain and level transform to map input temperature values to output gray scale values.

This non-linear transform 302, therefore, maps input temperature values in a non-linear fashion to gray scale output temperature values according to the transform curve. This non-linearity can be seen, for example, in how the spacings change among TA, TB, TC and TD on the X-axis and TA′, TB′, TC′ and TD′ on the Y-axis, as represented by where the dotted lines through points 310, 312, 314 and 316 hit the X-axis and the Y-axis, respectively. It is noted that the non-linear gain and level transform can be utilized to enhance the visibility to the user of desired aspects of the display image. As depicted, for example, the temperature range TA to TD has been compressed into a reduced dynamic range, particularly with respect to temperature range TA to TC. Thus, by in effect compressing the image into a reduced dynamic range, more useful temperature information can be visually represented to the user. Thus, the gain and level transform 302 can be configured as desired in order to achieve the visual results desired in the resulting image that is to be displayed.

In addition, the transform 302 may be changed dynamically during operation. For example, depending upon the overall scene content of the detected image, the transform 302 applied to input gray scale temperature values can be adjusted or selected dynamically. The transform 302 to be applied can be selected from a plurality of different non-linear and/or linear transforms that are stored in the imaging system. If desired, the transform 302 can be dynamically changed for each image frame depending upon the nature of the scene being detected by the imaging system. This dynamic application of non-linear transforms 302 provides for further advantages in presenting useful visual information to a user.

It is again noted that the number of temperature transition points or breakpoints, which is four in the examples above, can be varied as desired to accommodate the hardware design. It is noted that the non-linear gain and level transform 302 of FIG. 3, the color channel processing of FIG. 2, and the color segment processing of FIG. 1D can be used either alone or in any combination, as desired, depending upon the results desired in the image that is displayed to the user. It is further noted that any other system non-linearities may be similarly processed so that the output colors match the requested output for a given temperature.

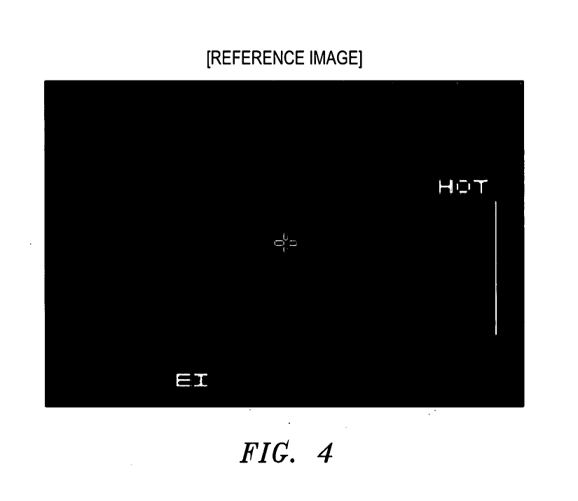

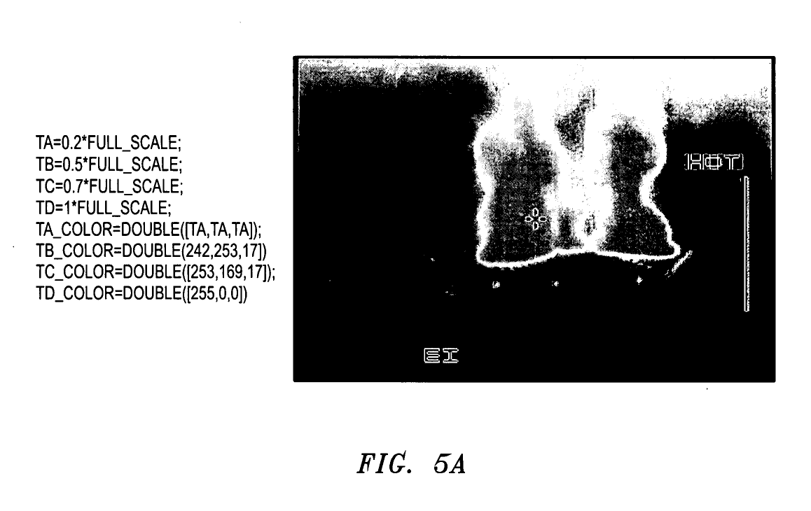

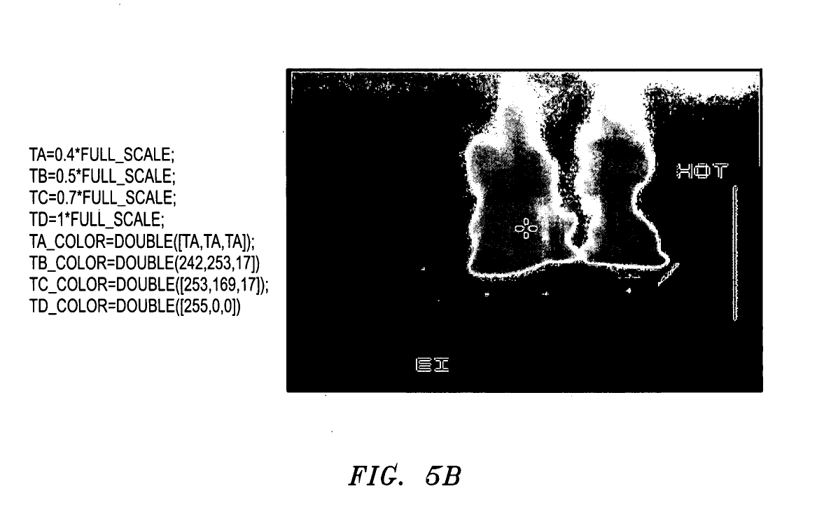

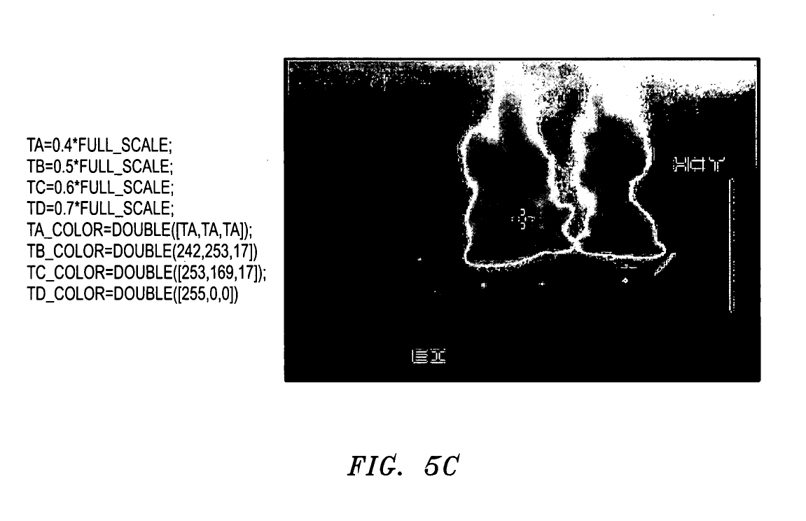

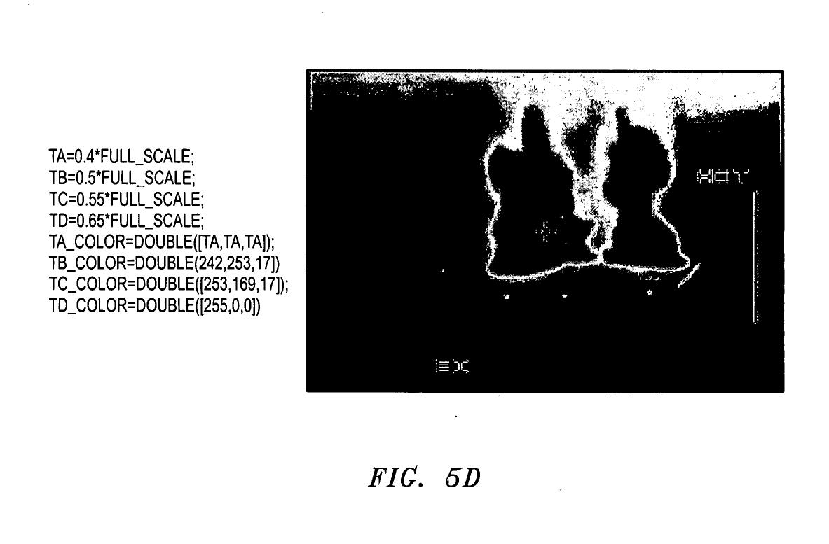

FIG. 4 (reference) and FIGS. 5A-D (colorized) provide example simulated images to show a representation of the enhancing effects of the colorization of the present invention. FIG. 4 is a reference image that has not been subjected to colorization processing according to the present invention. FIGS. 5A, 5B, 5C and 5D are images of the same scene that have been subjected to colorization processing according to the present invention. It is noted that in these simulated image examples, actual calibrated temperature values are not known, so temperature scaling numbers are not provided, and colorization is limited to gray scale colorization without mapping to known calibrated temperature values. Preferably, however, temperature calibration is first done for the imaging system so that gray scale values can be correlated to temperature values, as discussed above, and temperature-scaling can be included with the colorization as described herein.

Looking first to FIG. 4, a resulting image is depicted that includes burning fires. As depicted, this image includes graphics text on top of the image. This graphics text includes the word “HOT,” the bar at the right edge of the image, the letters “EI” at the bottom left of the image, and the cross-hairs in the middle of the image. This graphics text is repeated on FIGS. 5A-D, as well.

Looking next to FIGS. 5A-D, resulting images are depicted that have been subjected to colorization processing according to the present invention. The numbers at the left of the screen represent colorization parameters. The TA, TB, TC and TD parameters are user programmable setup values that represent a scaling of these temperature transition points with respect to “full scale” where “full scale” represents maximum temperature range that has been selected for the resulting image. For the purposes of these examples, “full scale” represents a maximum data value. The TA_color, TB_color, TC_color and TD_color parameters represent RGB triples in the form of ([X, Y, Z]) where X, Y and Z represent a value from 0 to 255 with 255 being full scale. The “double” routine represents a mathematical simulation routine (such as available in MATLAB) that generates a real number. Thus, the designation “double([X, Y, Z])” defines a particular color value assigned to the temperature transition points TA, TB, TC and TD.

FIG. 5A depicts a resulting image for which the following colorization parameters have been set so that certain aspects of the resulting thermal image are enhanced. In particular, the color transition points TA, TB, TC and TD and the color values for TA_color, TB_color, TC_color and TD_color have been configured. It is further noted that an actual output image could use both gray scale and color with the fires in the middle of the image being the portion of the image that is in color while the rest of the image is gray scale.
TA=0.2*full_scale
TB=0.5*full_scale
TC=0.7*full_scale
TD=1.0*full_scale
TA_color=double([TA, TA, TA])
TB_color=double([242, 253, 17])
TC_color=double([253, 169, 17])
TD_color=double([255, 0, 0])

FIG. 5B depicts a resulting image for which the following colorization parameters have been set so that certain aspects of the resulting thermal image are enhanced. With respect to FIG. 5A, the TA transition point has been changed from 0.2 to 0.4 of full scale.
TA=0.4*full_scale
TB=0.5*full_scale
TC=0.7*full_scale
TD=1.0*full_scale
TA_color=double([TA, TA, TA])
TB_color=double([242, 253, 17])
TC_color=double([253, 169, 17])
TD_color=double([255, 0, 0])

FIG. 5C depicts a resulting image for which the following colorization parameters have been set so that certain aspects of the resulting thermal image are enhanced. With respect to FIG. 5B, the TC transition point has been changed from 0.7 to 0.6 of full scale, and the TD transition point has been changed from 1.0 to 0.7 of full scale.
TA=0.4*full_scale
TB=0.5*full_scale
TC=0.6*full_scale
TD=0.7*full_scale
TA_color=double([TA, TA, TA])
TB_color=double([242, 253, 17])
TC_color=double([253, 169, 17])
TD_color=double([255, 0, 0])

FIG. 5D depicts a resulting image for which the following colorization parameters have been set so that certain aspects of the resulting thermal image are enhanced. With respect to FIG. 5C, the TC transition point has been changed from 0.6 to 0.55 of full scale, and the TD transition point has been changed from 0.7 to 0.65 of full scale.
TA=0.4*full_scale
TB=0.5*full_scale
TC=0.55*full_scale
TD=0.65*full_scale
TA_color=double([TA, TA, TA])
TB_color=double([242, 253, 17])
TC_color=double([253, 169, 17])
TD_color=double([255, 0, 0])

As indicated above, an example software module for channel colorization is included as an APPENDIX in the following page. This example module further describes example feature implementation for the embodiments above. It is also noted that the software module specification below is subject to the notice of copyright at the beginning of this specification.

### EXAMPLE

### Single Channel Colorization Module

%Purpose is to implement single channel colorization
%Inputs are temperature corner points and desired color at those points
%...this routine the linearly interpolates the color channel between
%...those points
%Assume the image to be colorized is named “I”
function[Colorized_I]≈single_channel_colorize(input_data);
[m,n]=size(input_data);
I(1:m−1,1:n)=input_data(2:m,1:n);
full_scale=255;
%Extract Temperature turnpoints
TA=input_data(1,1);
TB=input_data(1,3);
TC=input_data(1,5);
TD=input_data(1,7);
%Extract color values
TA_color=input_data(1,1); % first color is always same as gray scale
departure value
TB_color=input_data(1,4);
TC_color=input_data(1,6);
TD_color=input_data(1,8);
[m,n]=size(I);
%Colorize the image
for i=1:m

for j=1:n

if I(i,j)>TD

Colorized_I(i,j)=I(i,j);

elseif I(i,j)>TC

Colorized_I(i,j)=TC_color +
(TD_color−TC_color)*(I(i,j)−TC)/(TD−TC);

elseif I(i,j)>TB

Colorized_I(i,j)=TB_color +
(TC_color−TB_color)*(I(i,j)−TB)/(TC−TB);

elseif I(i,j)>TA

Colorized_I(i,j)=TA_color +
(TB_color−TA_color)*(I(i,j)−TA)/(TB−TA);

else

Colorized_I(i,j)=I(i,j);

end

end

end
%Show the image
%image(Colorized_I);
%Show color transition on test pattern

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A thermal image processing system, comprising:
a thermal image sensor having a plurality of individual detectors configured to detect thermal energy from a scene;
an image signal processor configured to convert signals from the detectors to digital pixel values related to thermal energy detected by the detectors, to assign a temperature value to each digital pixel value, and to apply non-linear colorization to the digital pixel values to provide colorized image temperature information; and
a display system coupled to receive the colorized image temperature information from the image signal processor and to display an image to a user.

2. The thermal image processing system of claim 1, wherein the non-linear colorization comprises colorization based upon a location of a temperature value for a given pixel within a temperature range.

3. The thermal image processing system of claim 2, wherein the temperature range is separated into a plurality of segments with each segment having a set of colorization parameters.

4. The thermal image processing system of claim 3, wherein the segments include one or more color segments and one or more gray scale segments.

5. The thermal image processing system of claim 4, wherein a number of segments is three or more, and the segment having a lowest range of temperatures is a gray scale segment and the segment having the highest range of temperatures is a gray scale segment.

6. The thermal image processing system of claim 3, wherein at least one segment is a color segment having a temperature range from a first temperature (X1) to a second temperature (X2), wherein a first color value (Y1) is assigned for temperature values equal to the first temperature, wherein a second color value (Y2) is assigned for temperature values equal to the second temperature, and wherein color values for temperature values between the first and second temperature value are determined by interpolation along a line between the first temperature and the second temperature according to the equation:
Y=m(X−T)+b
where X is the temperature value, Y is the color value, T is a marker value, b is an offset value, and m is a slope value defined by (Y2-Y1)/(X2-X1), and where m, T and b represent at least in part the set of colorization parameters for the color segment.

7. The thermal image processing system of claim 6, wherein a plurality of segments are color segments with each having a set of colorization parameters.

8. The thermal image processing system of claim 3, wherein the colorization comprises a multi-bit red value, and multi-bit green value, and a multi-bit blue value.

9. The thermal image processing system of claim 8, wherein a plurality of segments are color segments, and wherein a maximum digital value used for at least the red, green or blue value within at least one color segment is less-than an actual maximum digital value.

10. The thermal image processing system of claim 9, wherein 8-bit digital values are utilized for the red, green and blue multi-bit values such that the actual maximum digital value is 255.

11. The thermal image processing system of claim 1, wherein the image signal processor is further configured to assign a second temperature value to each digital pixel value based upon a non-linear transform and then to apply non-linear colorization to the second temperature value.

12. A colorization processing system for thermal imaging, comprising:
a digital input stream representing temperature values for image pixels representing temperatures within a scene;
colorization circuitry coupled to the digital input stream and configured to apply non-linear colorization to the temperature values based upon colorization parameters; and
color segment control circuitry coupled to the colorization circuitry to provide different sets of colorization parameters depending upon a location of the temperature values within a temperature range.

13. The colorization processing system of claim 12, wherein the temperature range is separated into a plurality of segments with each segment having a set of colorization parameters.

14. The colorization processing system of claim 13, wherein the segments include one or more color segments and one or more gray scale segments.

15. The colorization processing system of claim 14, wherein a number of segments is three or more, and the segment having a lowest range of temperatures is a gray scale segment and the segment having the highest range of temperatures is a gray scale segment.

16. The colorization processing system of claim 13, wherein the colorization circuitry comprises a marker (T) subtraction circuit, a slope (m) gain circuit, and an offset (b) adder circuit coupled to the digital input stream, wherein at least one segment is a color segment having a temperature range from a first temperature (X1) to a second temperature (X2), wherein a first color value (Y1) is assigned for temperature values equal to the first temperature, wherein a second color value (Y2) is assigned for temperature values equal to the second temperature, and wherein the marker (T) subtraction circuit, the slope (m) gain circuit, and the offset (b) adder circuit are configured to interpolate temperature values along a line between the first temperature and the second temperature according to the equation:
Y=m(X−T)+b
where X is the temperature value, Y is the color value, T is a marker value, b is an offset value, and m is a slope value defined by (Y2-Y1)/(X2-X1), and where m, T and b represent at least in part the set of colorization parameters for the color segment.

17. The colorization processing system of claim 13, wherein the colorization comprises a multi-bit red value, and a multi-bit green value, and a multi-bit blue value.

18. A method for colorization of images in an imaging system, comprising:
receiving a digital input stream representing digital values for image pixels representing detected scene energy; and
applying colorization to the digital input stream such that a relationship between a range of digital scene energy values and a range of color values is non-linear.

19. The method of claim 18, further comprising assigning a temperature value to digital values within the digital input stream to represent temperature values for the image pixels.

20. The method of claim 19, further comprising assigning a second temperature value to each digital pixel value based upon a non-linear transform.

21. The method of claim 20, further comprising dynamically changing the non-linear transform during operation.

22. The method of claim 21, wherein the non-linear transform is dynamically changed based upon overall scene content.

23. The method of claim 19, wherein the applying step comprises applying different sets of colorization parameters depending upon a location of a temperature value for a pixel within a temperature range.

24. The method of claim 23, further comprising separating the temperature range into a plurality of segments with each segment having a set of colorization parameters.

25. The method of claim 24, further comprising using one or more color segments and one or more gray scale segments.

26. The method of claim 25, wherein a number of segments is three or more, and the segment having a lowest range of temperatures is a gray scale segment and the segment having the highest range of temperatures is a gray scale segment.

27. The method of claim 24, further comprising allowing user configuration of at least some of the colorization parameters.

28. The method of claim 27, wherein the temperature ranges for one or more segments are user configurable.

29. The method of claim 18, further comprising displaying a resulting image to a user.
